(19) United States
(12) Patent Application Publication
(10) Pub. No.: US 2005/0180809 A1
(43) Pub. Date: Aug. 18, 2005

(54) Apparatus and method for securing print media

(75) Inventors: Yan Wu, Glenview, IL (US); Richard Maddrell, Barrington, IL (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Publications International, Ltd., Lincolnwood, IL (US)

(21) Appl. No.: 10/779,095

(22) Filed: Feb. 13, 2004

(51) Int. Cl. B42D 3/00

(52) U.S. Cl. 402/70

(57) ABSTRACT

A binding system comprising a spine adapted to be removeably secured within a base and a clip adapted to connect to the spine. The clip may be threaded through the aperture of a leaf to movably secure the leaf to the spine. Further, the spine may be elongated with a pair of mushroom-shaped ends. The base may further include a well having end walls with opposed dimples. The mushroom shaped heads may fit within the dimples to secure the spine to the base. The spine may include an aperture into which at least a portion of the clip may be inserted to secure the clip to the spine. The at least one leaf may be permitted to lie substantially flat upon the base when the spine is secured within the well.

### BACKGROUND OF THE INVENTION

The present invention relates to electronic interactive learning devices and methods in particular to an apparatus and method for securing print media to a base.

Interactive learning devices combining audible sounds and visual indicia are useful for a variety of purposes, including enhancing the comprehension and retention of displayed information, storytelling and learning experiences, testing one's skill and knowledge, and the like. Interactive learning devices of the aforementioned types often include a book having a number of leaves, which may cooperate with a base structure. The base structure usually houses electronics. Rather than providing separate base structures for each book, known interactive devices include removable and replaceable books so that a number of books may be used in a single base structure.

For such uses, bases may include electronic components capable of providing interaction between a user and visual indicia displayed in the book. Typically, such bases may include a stylus, or electronic pen, tethered to the base. The tip of the stylus may house electronic components that may interact with electronics embedded in the base, such that the precise location of the stylus may be identified when the stylus is pressed against the base, or placed in its immediate vicinity.

Accordingly, the book may be opened and placed on the base, wherein the user may utilize the stylus to initiate a sequence of events related to the visual indicia directly below the stylus, such as producing corresponding audible signals. Often, such audible signals are in the form of spoken words, songs or particular sounds associated with the text or pictures displayed in the book. Various techniques for producing such sound are known in the art.

Other types of systems are also known. For example, the base may include a plurality of pressure switches directly below the visual indicia of the book. The user may then apply pressure to the base, either by a finger or other device, to initiate an audible response associated with the particular switch and the visual indicia of the book directly above the switch. Systems incorporating magnetic switches with a magnetic pointer are also known. In such systems, the magnetic pointer may act to close a normally open circuit having a magnetic switch directly below visual indicia of an interactive book. The device may then respond with an audio signal related to such visual indicia.

The prior art interactive devices employing multiple books typically include means to provide sets of discrete audible signals associated with a given book to the base. Often, each book or a set of books may be provided with an associated cartridge capable of being plugged into the base. When the user changes books or sets of books, the user may also need to change cartridges so the correct audible signals will be produced for a given book. The electronics of the base work in conjunction with the definition set provided on the cartridge to produce the proper audio track for a given input.

The books used in association with the interactive devices may be bound or unbound. Typically, the books will be bound either by a spiral, wire or plastic binding, or traditional book binding techniques employing various adhesives, such as those used in conventional soft cover or hardbound book binding.

Traditional bindings, such as those used in soft cover or hardbound binding, are not favorable as these bindings make it difficult to lay the book flat on the base without compromising the integrity of the binding. It is not only aesthetically more pleasing to have the book lay flat upon the base, but it makes reading the book easier and often allows the electronics in the base to interact much more precisely.

Other binding systems that may permit a book to lay flat suffer from some of the same drawbacks. For example, spiral bindings permit a book to be laid flat. However, an inherent limitation of spiral binding is that the leaves on one side of the binding system are offset from the leaves on the opposite side by a distance equal to the thread pitch of the binding. This inherent limitation is generally undesirable in an interactive book. It is preferable to have open pages of a book form a rectangle with substantially straight edges, not offset edges. Substantially straight edges permit the well of the base, into which the book may be placed, to have substantially straight edges. Further, substantially straight edges permit the binding system of the book to be securely fastened within the well, as will be discussed hereinafter.

Another disadvantage of spiral bound books, which may be true of other binding systems, including wire or plastic binding systems, is that the spine does not include a surface onto which text or images associated with the particular book may be located. Thus, when a spiral bound, or similarly bound, book is placed on a shelf in the conventional manner with the spiral binding facing outwardly, the user will have no visual reference identifying the particular book. In order to ascertain the identity of the book, the user will either have to remember its location, or reference some other identifiable feature such as binding color or relative thickness. Conventionally, the book will have to be removed from the shelf in order to identify the title.

Still other prior art binding systems bind the individual leaves of books directly to a base unit of an interactive learning device and not to a separate spine. These base units typically include a series of receptacles wherein each is adapted to engage a clip. The clips are typically adapted to be inserted into the base unit receptacles to secure leaves through which the clips have been threaded.

Although these binding systems may be utilized to attach leaves of a book to a base, it would be advantageous if a complete book could be inserted into the base as a single unit, rather than individual leaves. In that regard, a complete book may be inserted by a small child or those with minimal dexterity. In addition, the risk of inserting new pages out of order, or losing a page, would be minimized. Finally, inserting a new book as a complete unit would be quicker and more efficient.

### SUMMARY OF THE INVENTION

In accordance with aspects of the present invention, there is disclosed a binding system adapted to be received by a base. The binding system may comprise a removeably securable spine for removeably securing the binding system to the base, and at least one clip securably attached to the spine. The clip may be shaped to be threaded through an aperture of a leaf to moveably secure the leaf to the spine. The spine may be elongated with a plurality of shaped ends for securing the binding system into the base. The shaped ends may be in the form of dimples or mushroom shaped heads, i.e., either convex or concave. The base may include a well having end walls with opposed shapes that the shaped heads may fit within to secure the spine to the base. These opposed shapes may be dimples or protrusions, and may either be convex or concave.

The spine may comprise an aperture into which at least a portion of the clip may be inserted to secure the clip to the spine. The spine may also comprise a pair of apertures where the clip comprises a first leg and a second leg connected by a bite portion. In this case, the first leg may be adapted to be inserted into one of the apertures and the second leg may be adapted to be secured within the other of the apertures to secure the clip to the spine.

The spine may have an interior surface facing toward the leaf and an exterior surface facing away from the leaf. The exterior surface may be substantially curved from side to side, along the length of the spine. The shaped ends of the spine may be flush with the curved exterior surface of the spine, such as when the shaped ends are mushroom-shaped. The shaped ends may extend beyond the interior surface of the spine.

In other aspects of the present invention, a book binding system for use with a base may comprise a removeably securable elongated spine having at least a first aperture opposed from at least a second aperture and at least one clip comprising at least first and second legs sized to be received by the at least first and second apertures for securing the clip to the elongated spine. The legs may have a bite portion therebetween. The at least first and second legs each may comprising an extension member extending therefrom. Each of the extension members may comprise a tab terminating with a foot extending therefrom. The at least first and second legs may be secured through the at least first and second apertures.

The spine may further comprise a third aperture adjacent the first aperture and a fourth aperture adjacent the second aperture. The third aperture may be opposed from the fourth aperture. Each leg of the clip may further comprise second tabs terminating with feet extending therefrom. The feet may be adapted to be secured within the first, second, third and fourth aperture.

The first pair of apertures and the second pair of apertures may be spaced from each other along the width of the spine.

The elongated spine may include a first end and a second end, the first end having a first convex head and the second end having a second convex head. The spine may have an interior surface facing toward the leaves of the book and an exterior surface facing away from the leaves of the book. The exterior surface may be substantially curved from side to side, along the length of the spine. The first convex head and the second convex head may be flush with the curved exterior surface of the spine. The first convex head and the second convex head extend beyond the interior surface of the spine.

The exterior surface of the elongated spine may include a recessed area encompassing the first pair of apertures and the second pair of apertures. The recessed area may include indicia of information.

The elongated spine may include a first end and a second end, the first end having a concave or alternatively a convex surface adapted to engage the base.

The binding system may further comprise a base having a recessed area adapted to accept the spine of the book. The print media of the book is preferably adapted to lie substantially flat on the base.

The recessed area of the base may culminate in walls having concave portions and the spine may include ends having convex heads such that the convex heads of the spine fit within the concave portions of the recessed area when the spine is placed within the recessed area.

The recessed area of the base may also culminate in at least one wall having a convex portion and the spine may include at least one end having a head with a concave portion such that the concave portion fits within the convex portion of the recessed area when the spine is placed within the recessed area.

The recessed area of the base may also culminate in at least one wall having a concave portion and the spine may include at least one end having a head with a convex portion such that the convex portion fits within the concave portion of the recessed area when the spine is placed within the recessed area.

In accordance with further aspects of the present invention, an apparatus for securing print media may comprise a base, a removeably attachable elongated spine, and at least one clip adapted to be attached to the spine. The clip may be threaded through apertures provided in print media and secured to the spine to form a book, the book being adapted for attachment into a recess in the base. The print media of the book may be adapted to lie substantially flat on the base.

The spine may include a pair of convex heads and the recess may culminate at its extreme ends with concave walls, the convex heads being adapted to fit within the concave walls.

The spine may include at least one head having a dimpled portion, the dimpled portion may be adapted to engage a protrusion extending from the recess to secure the spine to the base.

The spine may include at least one head having a convex portion, the convex portion may be adapted to engage a concave portion of the recess to secure the spine to the base.

In yet further aspects of the present invention, a binding system for a book having a plurality of leaves may comprise an elongated spine having a first aperture and a second aperture spaced apart from the first aperture, and a clip having first and second legs extending from a bite portion, the first leg having a first foot and the second leg having a second foot. The first foot and the first leg may be adapted to be threaded through apertures provided in the leaves of a book such that the leaves are retained about the clip when the first foot and the second foot are inserted into the apertures of the elongate spine.

The first aperture and the second aperture may be spaced from each other along the width of the spine.

The binding system may further comprise a base having a recessed area adapted to receive the spine of the book.

In still further aspects of the present invention, there is provided a method of removably securing a first book comprising leaves of print media bound to an elongated spine having end portions to a well formed in the base of an interactive learning device may comprise placing the elongated spine of the first book into the well of the base such that the spine is removably secured within the well by the end portions of the spine.

The base may further comprise a cartridge port for securing a cartridge associated with a particular book therein, where the method further comprises inserting a cartridge into the cartridge port, the cartridge being associated with the first book.

This preferred method may further comprise removing the first book from the base such that the spine is no longer secured within the well by the end portions of the spine.

In further aspects of the present invention, there is disclosed a method of successively securing a plurality of books comprising leaves of print media bound to an elongated spine having end portions to a well formed in the base of an interactive learning device, the method comprising placing the elongated spine of a first of the plurality of books into the well of the base such that the spine of the first book is removably secured within the well by the end portions of the spine thereof.

Preferably, the method may further comprise removing the first book from the base such that the spine of the first book is no longer secured within the well by the end portions of the spine thereof.

More preferably, the method may further comprise placing the elongated spine of a second of the plurality of books into the well of the base such that the spine of the second book is secured within the well by the end portions of the spine thereof.

The method may preferably further comprise removing the second book from the base such that the spine of the second book is no longer secured within the well by the end portions of the spine thereof.

Preferably, the method may further comprise placing the elongated spine of a third of the plurality of books into the well of the base such that the spine of the third book is secured within the well by the end portions of the spine thereof.

In further aspects, there is provided a method of swapping books from the base of an interactive learning device wherein the books comprise spines having convex end portions adapted to be secured within a well formed in the base. The method may preferably comprise inserting a first book into a well formed in an interactive learning device such that the convex end portions of the spine of the first book secure the book within the well, removing the first book from the well, and inserting a second book into the well such that the convex end portions of the spine of the second book secure the second book within the well.

Each of the first and second books may preferably include a cartridge associated therewith and the base may include an input port for the cartridge. The method may further comprise removing the cartridge associated with the first book from the cartridge input port and inserting the cartridge associated with the second book into the cartridge input port.

In yet another embodiment, a method of swapping books from the base of an interactive learning device wherein the books comprise spines having at lease one concave end portion adapted to be secured within a well formed in the base may comprise inserting a first book into a well formed in an interactive learning device such that the at least one concave end portion of the spine of the first book secures the book within the well, removing the first book from the well, and inserting a second book into the well such that the concave end portion of the spine of the second book secures the second book within the well.

### BRIEF DESCRIPTION OF THE DRAWINGS

The subject matter regarded as the invention is particularly pointed out and distinctly claimed in the conclusion portion of the specification. The invention, however, both as to organization and method of operation, together with the features, objects, and advantages thereof, may best be understood by reference to the following detailed description when read with the accompanying drawings in which:

FIG. 1 is a top plan view of an educational device in accordance with one embodiment of the present invention wherein the educational device is in the open position and is complete with a book attached thereto;

FIG. 2 is a top plan view of the educational device of FIG. 1 shown in a closed position;

FIG. 3 is a plan view of the educational device of FIG. 1 shown without a book attached;

FIG. 4 is a bottom plan view of the educational device of FIG. 1;

FIG. 5 is a top perspective view taken of the educational device of FIG. 1 shown in a closed position;

FIG. 6 is a right-hand perspective view of the educational device of FIG. 1 shown in a closed position;

FIG. 7 is a bottom perspective view of the educational device of FIG. 1 in the closed position;

FIG. 8 is a left-hand perspective view of the educational device of FIG. 1 in the closed position;

FIG. 9 is a perspective view of a book forming a portion of certain embodiments of the educational device of the present invention;

FIG. 10 is a rear perspective view of the book of FIG. 9;

FIG. 11 is a top plan view of the book of FIG. 9 shown in the open position;

FIG. 12 is a plan view of the exterior of the spine forming a portion of the book of FIG. 9;

FIG. 13 is a plan view of the interior of the spine forming a portion of the book of FIG. 9;

FIG. 14 is a perspective view of the educational device of FIG. 1 shown in the open position without a book attached thereto;

FIG. 15 is a perspective view of a clip forming a portion of certain embodiments of the educational device of the present invention;

FIG. 16 is a plan view of the side of the clip of FIG. 15; and,

FIG. 17 is a perspective view of a clip partially installed into a spine in accordance with several aspects of the present invention.

### DETAILED DESCRIPTION

In describing the preferred embodiments of the subject matter illustrated and to be described with respect to the drawings, specific terminology will be resorted to for the sake of clarity. However, the invention is not intended to be limited to the specific terms so selected, and it is to be understood that each specific term includes all technical equivalents that operate in a similar manner to accomplish a similar purpose.

In this regard, the device of the present invention suitably lends itself to a variety of applications. While the device will be described generally as an educational device for illustrative purposes only, it is to be understood that other applications for such a device, for example, an electronic quiz book, an interactive electronic device, and the like, are within the scope of the present invention. The construction of the device lends itself to combining audible sounds and visual indicia for a variety of end applications, educational or otherwise.

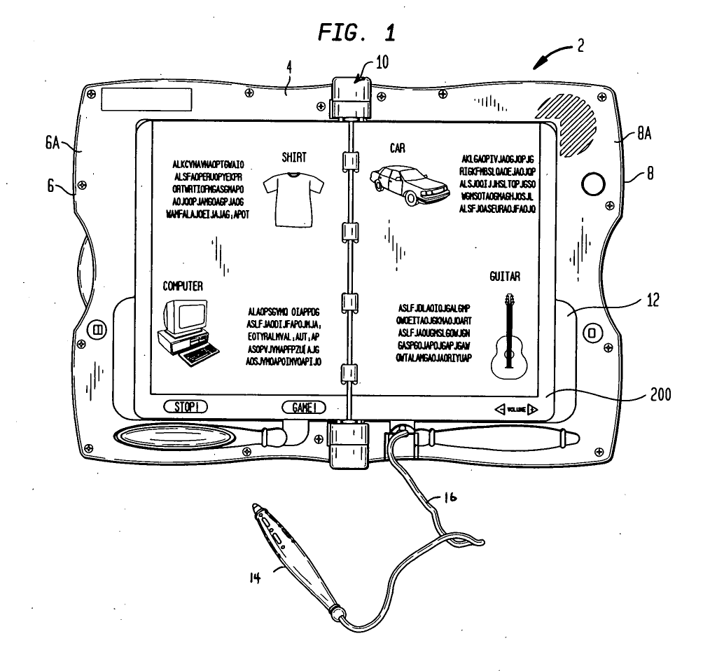

Referring to FIG. 1, there is disclosed an educational device 2 constructed in accordance with one embodiment of the present invention. The educational device 2 preferably includes a base 4 having top and bottom covers 6, 8 forming and connected to each other by a hinge 10. Alternatively, the base 4 may not be hinged, but stationary and thus may be incapable of being closed. It may simply comprise a single board or platform. It will be appreciated that the top and bottom covers 6, 8 are shown in FIG. 1 in the open position, such that their inside surfaces 6A, 8A are shown. A depressed area, or well 12, may be formed within the inside surfaces 6A, 8A of the top and bottom covers 6, 8, as shown. As also shown in FIG. 1, a book 200 may be placed within the well area 12 of the base 4. Finally, a stylus 14 may be electrically and mechanically tethered to the inside surface 8A of bottom cover 8 by a cord 16. Alternatively, the stylus 14 may be cordless or wireless and may interact with the base 4 through free-wave transmission. Such transmission may include, but is not limited to, RF or infrared transmitter/receivers.

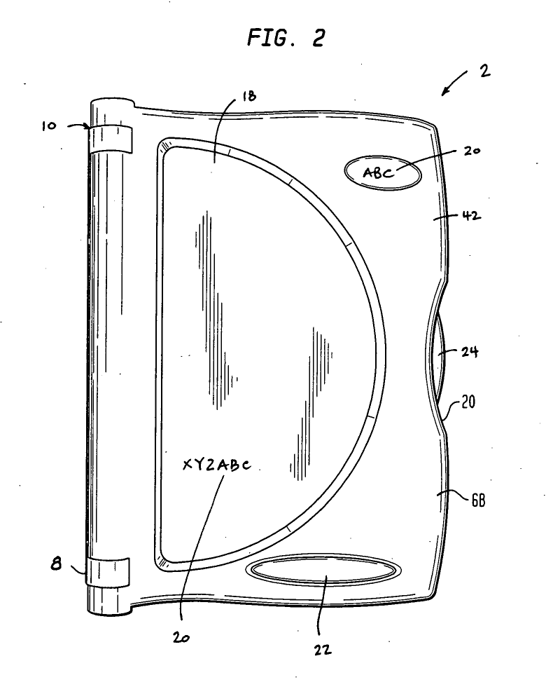

FIG. 2 depicts a top plan view of the educational device 2 in a closed position. As shown in FIG. 2, the outside surface 6B of top cover 6 may include a recessed area 18 provided with visual indicia 20 associated with the educational device 2 or serving other purposes. Other areas of the outside surface 6B of top cover 6 may also include visual indicia 20, even if not recessed. The top cover 6 may also include a window 22 through which portions of the stylus 14 housed between the inside surface 6A of the top cover 6 and inside surface 8A of bottom cover 8 may be viewed. The translucent portion or window 22 is preferably made of a translucent and most preferably clear plastic material, such as Lexan® or acrylic, but may be formed from other materials such as glass. Lexan® is a registered trademark of the General Electric Company, One River Road, Schenectady, N.Y. U.S.A. Clear plastic materials are preferable over glass as they reduce the risk of breakage and potential injury to the operator or others caused by such breakage.

A latch actuator 24 may extend from within the top cover 6, between the top cover inside surface 6A and top cover outside surface 6B. As will be discussed, the latch actuator 24 may be pressed and forced partially inward within the top cover 6 to disengage a locking mechanism from securing the top cover 6 to the bottom cover 8.

Portions of the bottom cover 8 are also visible in this top plan view. These portions interact with portions of top cover 6 to form hinge 10. Hinge 10 acts to connect the top and bottom covers 6, 8, and serves as a pivoting means for opening and closing the base 4. The hinge 10 will be discussed in greater detail below.

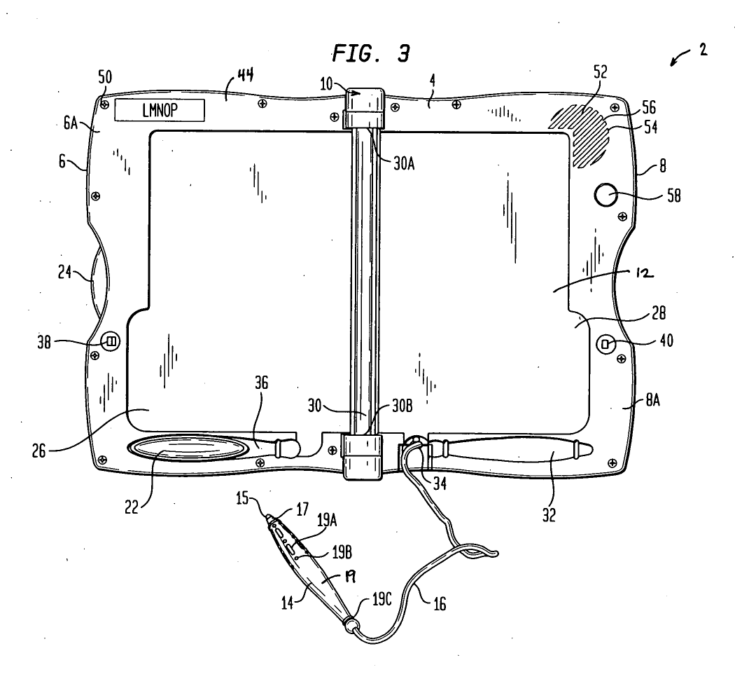

FIG. 3 depicts a top plan view of the educational device 2 in the open position with book 200 completely removed and not shown. In the orientation shown in FIG. 3, top cover 6 is on the left-hand side while bottom cover 8 is on the right-hand side and stylus 14 is located on the bottom. This is the typical orientation in which the user will utilize the educational device 2. It will be appreciated from this view that well 12 may comprise three distinct sections; namely, a top cover well 26 formed within the top cover 6, bottom cover well 28 formed within the bottom cover 8, and a spine well 30 formed within the hinge 10. As will be discussed hereinafter, distinct portions of the book 200 may be designed to fit securely within the top cover well 26, bottom cover well 28, and spine well 30.

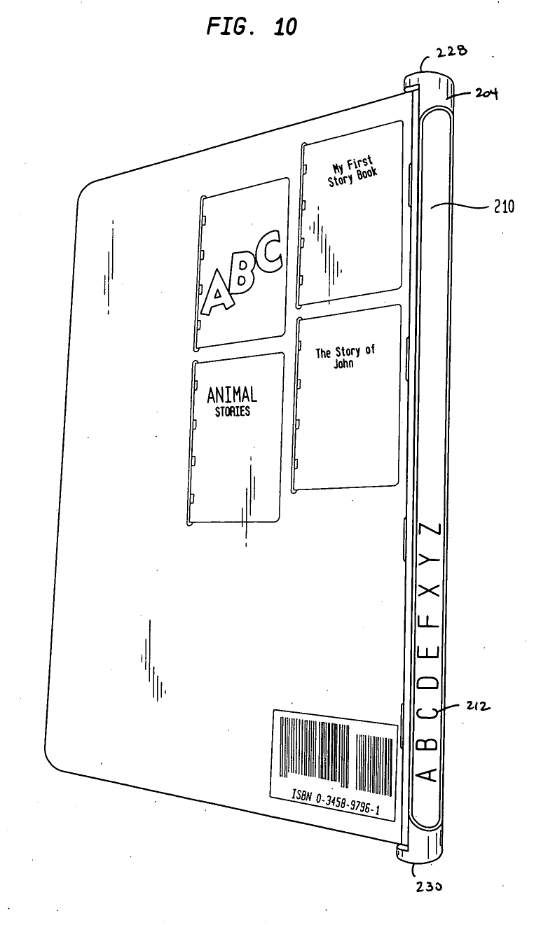

Alternatively, there may be a single well in which the entire book 200 may be placed. Additionally, the top cover well 26 and bottom cover well 28 may be oversized in relation to the book 200. For this reason, the top cover well 26 and bottom cover well 28 are not necessarily used to position the book 200. In some embodiments, the well 12 may taper such that its depth is not consistent. If the well 12 tapers, it is preferable that the well 12 be deepest adjacent the spine 204 (FIG. 10) of the book 200.

Also provided on bottom cover 8 is a bottom cover stylus well 32. The bottom cover stylus well 32 may be shaped similarly to the stylus, such as shown in FIG. 2, or may be or other configurations such as a simple rectangle. Generally, the bottom cover stylus well 32 is a localized depressed area wherein the stylus 14 may be stored. Meanwhile, the cord 16 of stylus 14 may be inserted into a cord aperture 34 provided within the bottom cover 8 and opening into the bottom cover stylus well 32.

The top cover 6 may also include a top cover stylus well 36 formed opposite the bottom cover stylus well 32 such that the bottom cover stylus well 36 and top cover stylus well 32 will be adjacent each other when the base 4 of the educational device 2 is in the closed position. In this regard, portions of the stylus 14 rest within the bottom cover stylus well 32 and other portions of the stylus rest within the top cover stylus well 36 when the stylus is placed therein and the base 4 is in the closed position. As previously discussed, when in such a position, portions of the stylus may be viewed through the window 22 formed in the top cover 6 of base 4.

The stylus 14 is preferably formed into the shape of a pen or other pointing device. The stylus 14 may include a cone-shaped tip 15 at its distal end 17 to facilitate precise pointing. The tip 15 may include electronic components, such as a magnet. The stylus 14 may also include rubberized portions set into its shaft 19 to facilitate handling by a user. The rubberized portions may include a rubber line-segment 19A, rubber button 19B, or rubber ring 19C. In addition to adding aesthetic value, the rubberized portions 19A, 19B, 19C assist the user with gripping the stylus 14, which is otherwise typically formed from rigid plastic or the like.

As previously stated, the latch actuator 24 may extend from within the top cover 6. The latch actuator 24 may be mechanically and directly connected to a latch 38 protruding from the inside surface 6A of top cover 6 such that it points directly toward a latch capture aperture 40 formed within the inside surface 8A of bottom cover 8 when the base 4 is in the closed position. When the base 4 is in the closed position, actuation of the latch actuator 24 will engage or disengage the latch 38 from the latch capture aperture 40 formed within the bottom cover 8. Latches 38 and mechanisms for actuating the latch are well known in the art, and may be employed for this purpose.

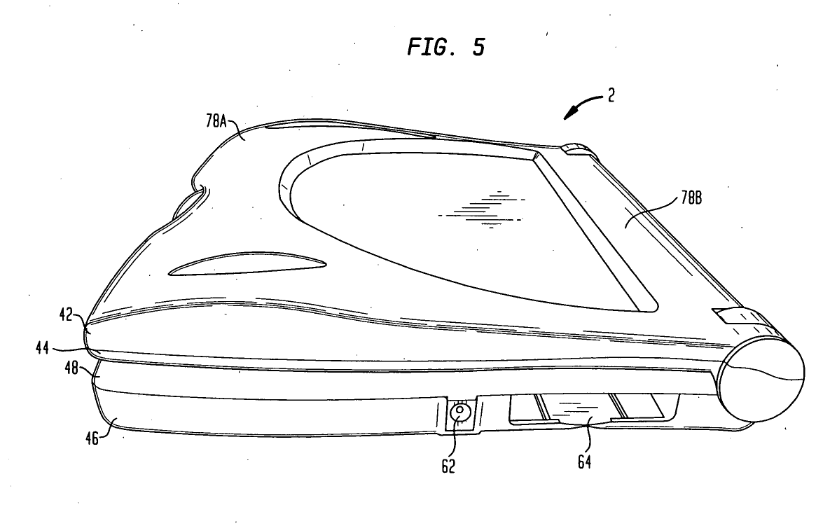

Referring briefly to FIG. 5, it will be appreciated that the top cover 6 and bottom cover 8 are each typically formed from two (2) halves. Accordingly, the top cover outside half 42 and the top cover inside half 44 may be mechanically or chemically joined with various components, including the latch actuator 24, latch 38, and various electronics, sandwiched therebetween. As shown in FIG. 3, the top cover inside half 44 and top cover outside half 42 (FIG. 2) are joined by a series of mechanical fasteners, such as screws 50. Likewise, as shown in FIG. 5, the bottom cover outside half 46 and the bottom cover inside half 48 may be joined with various similar components sandwiched therebetween. The means for connecting the bottom cover inside half 48 to the bottom cover outside half 46 are similar to those for connecting the top cover outside half 42 to the top cover inside half 44, and include screws 50, as shown in FIG. 3. Although the screws 50 have been shown with Phillips type heads, it is to be understood that other configurations may be utilized. Such configurations may include “regular” heads, hex heads, torx heads, or the like. Also, other means of connecting the pieces together are contemplated by the present invention, including heat sealed, compression fit, molded form, engaging tabs and other conventional methods.

Referring back to FIG. 3, a speaker grill 52 may be formed in the inside surface 8A of the bottom cover 6. The speaker grill 52 comprises a series of raised ribs 54 having slotted apertures 56 there between. The slotted apertures 56 permit sound emanating from a speaker (not shown) within the bottom cover 8 to be heard, but substantially protect the electronic components contained therein. Activity button 58 may extend through the bottom cover inside half 48 from within the bottom cover 8. The activity button 58 may be utilized to activate or deactivate the electrical components contained within the base 4 of the educational device 2. As such, the activity button 58 may sometimes be referred to as an “on/off” button.

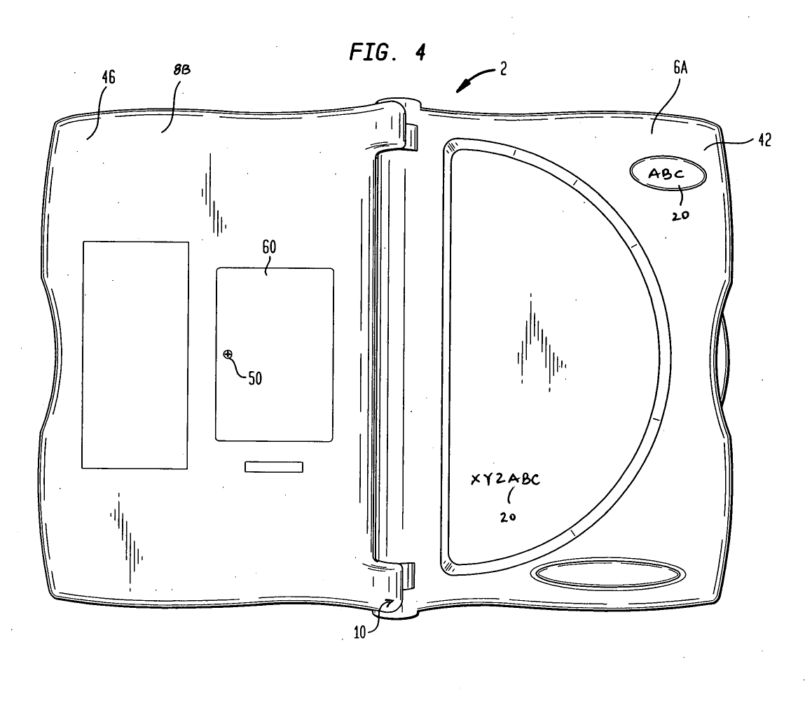

FIG. 4 depicts a bottom plan view of the educational device 2 in an open position such that the outside surfaces 6B, 8B of the top and bottom covers 6, 8, are shown. In this view, the bottom cover outside half 46, top cover outside half 42, and underside of hinge 10 may be seen clearly. For aesthetic purposes, screws 50 (FIG. 3) do not penetrate either top cover outside half 42 or bottom cover outside half 46, and are not visible in this view. Rather, threaded receptacles may be provided within the bottom cover outside half 46 and top cover outside half 42 to receive screws 50.

A battery cover 60 may form a portion of bottom cover outside half 46. The battery cover 60 is preferably joined to bottom cover outside half 46 by removable means. Such means may include various mechanical means such as a friction or pressure fittings, engaging tabs, heat sealing molded form, or screw 50, as shown in FIG. 4. The removal of screw 50 and the opening of the battery cover 60 reveals a battery housing (not shown) for replacement of batteries utilized to power the electronic components of the educational device 2.

As shown in FIG. 5, the bottom cover 8 may include a power receptacle 62 and a cartridge receptacle 64. The power receptacle 62 is designed to accept the input of a power cord (not shown), such as that providing a 6 volt d.c. current. Typically, this power source will be obtained through a transformer plugged into a 112-volt outlet, such as commonly found in the home. This power source may be used in lieu of, or in conjunction with, the previously mentioned batteries. The power source may be sized and shaped to a conventional standard known in the industry, such that a variety of power cords, including certain classes of “universal” power cords, may be utilized. One such power cord that may be utilized is a coaxial-style in-line DC power plug having an outside diameter tip size of 5.5 mm, an inside diameter tip size of 2.5 mm, with a barrel length of approximately 9.5 mm. If desired, however, the power receptacle 62 may be custom formed such that proprietary devices may only be utilized.

The cartridge receptacle 64 is designed to accept the input of a cartridge (not shown) which may be associated with the book 200 to provide instructions to the educational device 2. The cartridge may provide an instruction set corresponding to a particular book such that the audio signal emanating from speaker grill 52 will be associated with the visual indicia of book 200 with which the stylus 14 comes in contact or close proximity. The cartridge typically includes a plastic housing having an electronic circuit board within its hollow interior. The circuit board may include male protrusions that may engage female receptacles formed within the cartridge receptacle 64, which are adapted to mechanically and electronically mate therewith.

The power receptacle 62 and the cartridge receptacle 64, shown in FIG. 5, may be formed entirely from the bottom cover outside half 46. It will be appreciated that this need not be the case, and the receptacles 62, 64 may be partially formed in the bottom cover outside half 46 and bottom cover inside half 48, if so desired. Similarly, the power receptacle 52 and the cartridge receptacle 64 may be formed entirely within the bottom cover inside half 48, or in various combinations of the top cover outside half 42 and inside half 44.

FIG. 6 depicts a right side perspective view of the educational device 2 according to one embodiment of the present invention where the educational device is in the closed position. In this view, the latch actuator 24 is clearly shown penetrating the top cover 6. In order to do so, the top cover outside half 42 includes a latch actuator notch 66, which forms a latch actuator aperture 68 when the top cover outside half 42 and the top cover inside half 44 are brought together. Actuation of the latch actuator 24 is preferably limited to movement into or out of the top cover 6 along a plane parallel to the top cover. Movement in other directions is preferably minimized.

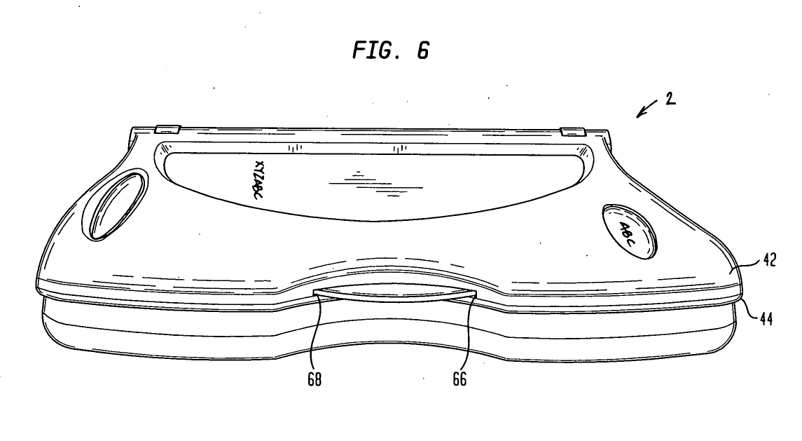

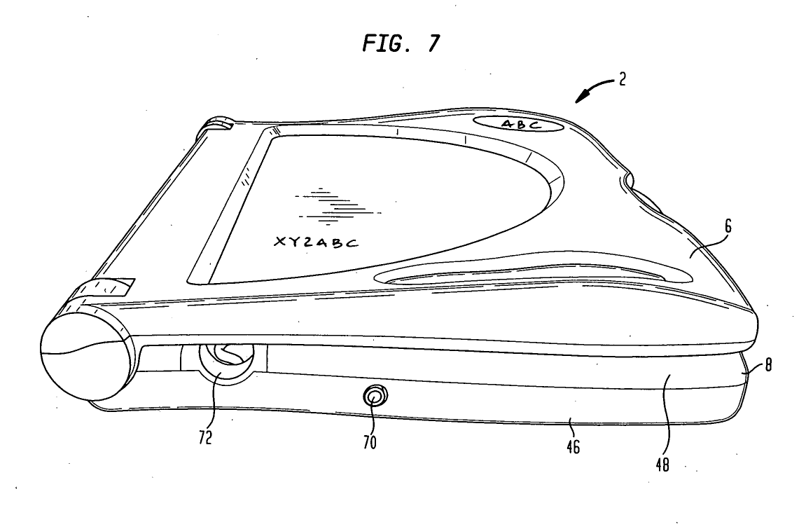

Referring now to FIG. 7, a lower perspective view of the educational device 2 in accordance with one embodiment of the present invention, the bottom cover 8 may have an audio output port 70, such as a headphone jack. This audio output port 70 permits the insertion of the plug from an audio speaker source, such as headphones (not shown), for transferring an audio signal from the electronic component of the educational device 2 to a user. Typically, the audio output port 70 is configured to match conventional standards, such that conventional audio speaker sources may be utilized. For example, the port may be adaptable for use with ⅛″ diameter headphone plugs commonly available. The audio output port 70 may transfer either a mono or stereo signal, as is designed by the designer.

The bottom cover 8 may be locally depressed to form a cord depression 72 allowing portions of the cord 16 to extend from within the closed top cover 6 and bottom cover 8. It will be appreciated that the cord 16 may also be stowed within the cord aperture 34 (FIG. 3), as previously discussed. Typically, the cord depression 72 will be deeper than the bottom cover inside half 48, such that it extends into the bottom cover outside half 46. In this regard, the cord depression 72 should at least be large enough to permit the cord 16 to extend out of the closed base 4 and then return back, such that the cord must essentially pass through the cord depression twice.

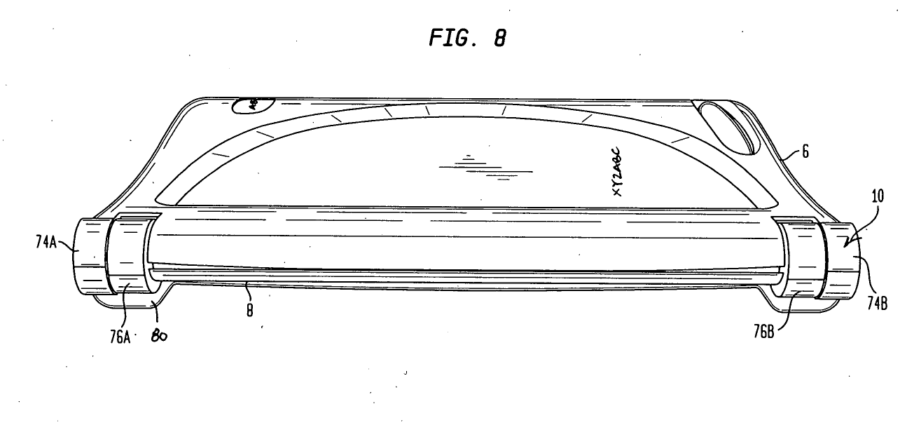

As shown in FIG. 8, and as previously discussed, the top cover 6 and bottom cover 8 include portions forming hinge 10. More particularly, the top cover 6 includes portions forming top cover cylindrical sections 74A, 74B and the bottom cover 8 includes portions forming bottom cover cylindrical sections 76A, 76B. The respective cylindrical sections 74A, 76A and 74B, 76B may be placed adjacent to each other with a shaft (not shown) running therebetween to form hinge 10. Typically, two (2) shafts are utilized, one extending from the top cover cylindrical section 74A into the bottom cover cylindrical section 76A and the other extending from top cover cylindrical section 74B into the bottom cover cylindrical section 76B. Given this arrangement, there is no need for a shaft to run between the two (2) bottom cover cylindrical sections 76A, 76B, in the area where spine well 30 (FIG. 2) is located.

Referring back to FIG. 5, it will be appreciated that the top cover 6 includes a portion 78A which is thicker than the remaining portion 78B. Referring to FIG. 8, it will be appreciated that the bottom cover 8 includes a pair of extension members 80 supporting the bottom cover cylindrical sections 76A, 76B. The combination of the thicker portion 78A and the extension members 80 serve to support the base 4 when the base is in the open position. The support provided serves to place the base 4 in a relatively flat position, such that the inside surface 6A of the top cover 6 is generally co-planar with the inside surface 8A of the outside cover 8.

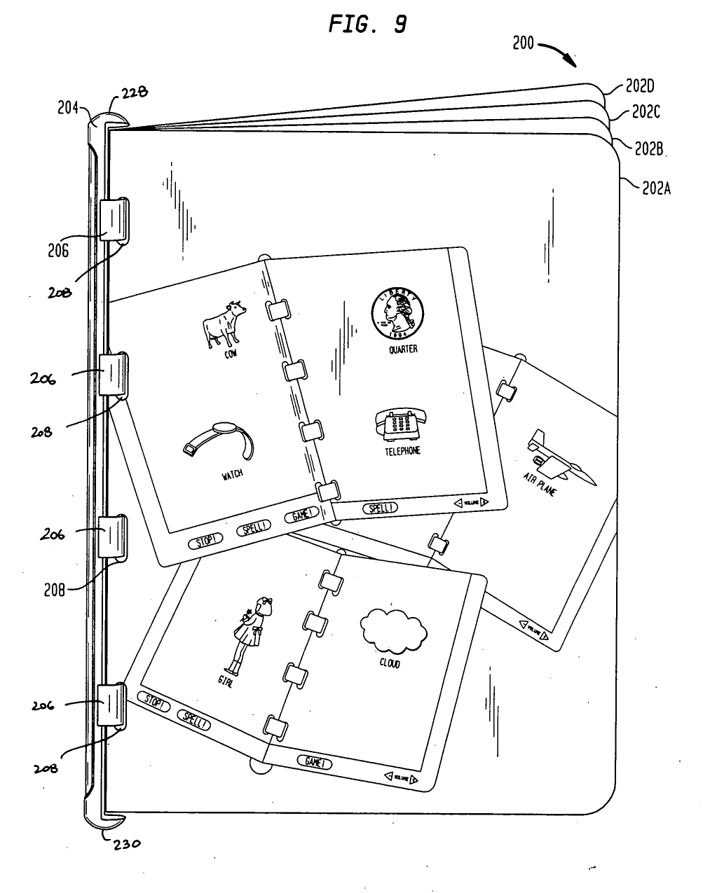

As previously discussed with reference to FIG. 1, a book 200 forming a portion of the educational device 2 of the present invention may be provided wherein the book is adapted to be inserted into the base 4. As shown in FIG. 9, the book typically comprises a plurality of leaves 202, including a front cover 202A, a rear cover 202D, and interior leaves 202B and 202C. The book 200 also comprises a spine 204 having a plurality of clips 206 attached thereto. The clips 206 may be threaded through slotted apertures 208 provided in each of the leaves 202 of the book 200, such that the leaves may be retained thereby. As will be discussed, the clips 206 are preferably attached permanently to the spine 204, and may only be removed destructively.

As shown in FIG. 10, the spine 204 includes a display portion 210 wherein informational material 212 about the book 200 may be displayed. The informational material 212 may be printed upon a sticker to be affixed to the spine 204 by adhesives, or may be printed directly thereon. Alternatively, the spine 204 may comprise an additional rear panel (not shown) which may be attached to the spine and upon which the sticker may be affixed.

Generally, the informational material may include the name of the book, the subject matter contained within the book, age of the child for which the book is appropriate, as well as other information generally known in the art. It will be appreciated that when the book 200 is placed on a shelf in the conventional manner, the informational material 212 will be readily displayed to potential users of the book. In addition, the spine 204 may be curved to promote easy reading of the display portion 210 from a variety of angles.

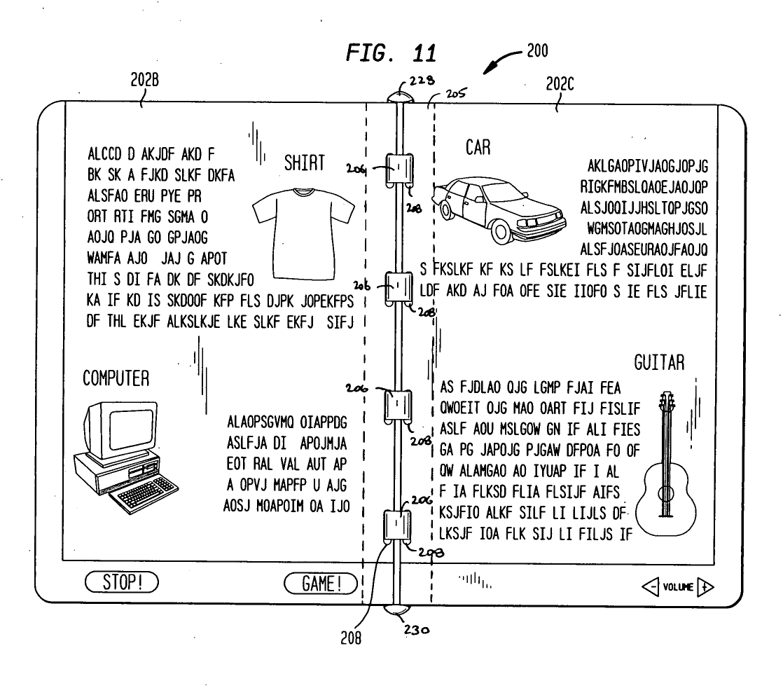

The combination of the spine 204 and clips 206 permit the leaves 202 of the book 200 to lay substantially flat when the book is open such as shown in FIG. 11 where leaves 202B and 202C are visible. It will also be appreciated that the slotted apertures 208 are generally somewhat oversized compared to the clips 206, such that there is little interference between the leaves 202 of the book 200 and the clips 206. This relationship promotes easy turning of the leaves 202 by a small child or those having minimal dexterity. Preferably, however, the slotted apertures 208 are not so big as to permit the leaves 202 to slide unnecessarily out of alignment with each other.

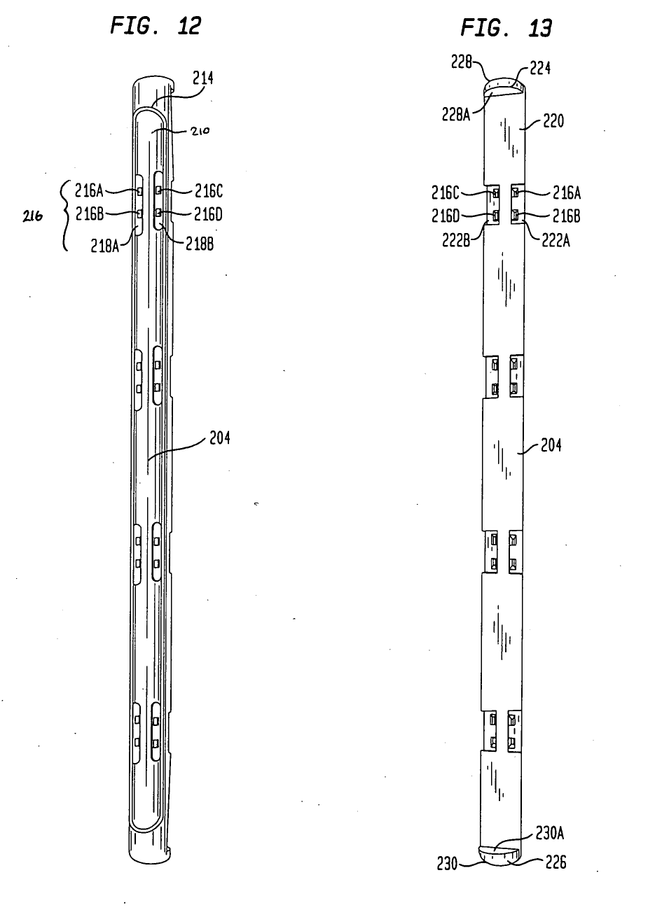

The display area 210 of the spine 204 is preferably recessed such as shown in FIG. 12, where the display area extends along almost the entire length of the spine and culminates in arched portions 214. The display area 210 may also be curved or bulged outwardly, to match the remainder of the spine. Alternatively, the display area 210 may be flat. Apertures 216 extend through the spine 204 at even intervals within the display area 210.

As shown in FIG. 12, the apertures 216 may be grouped in sets of four (4) apertures 216A, 216B, 216C, and 216D. Pairs of the apertures 216 are themselves provided in a recessed area 218, further recessed from the recessed display area 210. For example, apertures 216A and 216B may be provided in one recessed area 218A, while apertures 216C and 216D may be provided in a second recessed area 218B. Preferably, the spine 204 includes a total of eight (8) recessed areas 218 having two (2) apertures 216 disposed in each. One advantage to including recessed areas 218 is the recessed areas permit penetration of the spine 204 only to a certain degree. For example, recessed areas 218 permit penetration and locking of the clip 206 without permitting penetration of the clip beyond the display area 210 of the spine 204. Thus, when a sticker displaying informational material 212 is placed on the spine 204, the informational material may lie substantially flat thereagainst.

The inside surface 220 of spine 204 is shown in FIG. 13. Whereas the display area 210 of spine 204 is preferably curved, the inside surface 220 is preferably flat. The apertures 216, visible in the display area 210 of the spine 204, extend through the spine such that they are visible in FIG. 13. As with the display area 210, the portions of the inside surface 220 of the spine 204 adjacent pairs of apertures 216 include localized recessed areas 222. For example, apertures 216A and 216B share a recessed area 222A, while apertures 216C and 216D share a recessed area 222B. In all, a total of eight (8) recessed areas 222 are preferably included with each of the eight (8) recessed areas including two (2) apertures 216.

At each of the first end 224 and second end 226 of the spine 204 may be convex heads, first convex head 228 at the first end 224 and second convex head 230 at the second end 226. The convex heads 228, 230 are preferably mushroom-shaped, or convex, and provide multiple advantages.

First, they provide a mechanism for securing the book 200 within the base 4 of the educational device 2. For example, referring to FIG. 14, the spine well 30 may include recessed portions 31A, 31B in its end walls 30A, 30B. The recessed portions are typically formed into the shape of dimples, which are slightly larger, and which are adapted to accept, the convex heads 228, 230 of the spine 204. It will be appreciated that the spine 204 may be slightly flexible such that it may be flexed upon insertion only to rebound and be held therein. Notwithstanding this flexibility, the spine 204 is preferably sufficiently rigid, and the tolerances of the spine 204, spine well 30, spine walls 30A and 30B, and recessed portions 31A and 31B sufficiently tight, so that the spine may not inadvertently be removed from the spine well after insertion. Preferably, the base 4 may even be turned upside-down, without the book 200 becoming unsecured. This is a particularly useful feature where the educational device 2 is intended to be used by young children.

In addition to serving to secure the spine 204 within the base 4, the convex heads 228, 230 provide boundaries for retaining the leaves 202 of the book therebetween. As previously discussed, the slotted apertures 208 of the book 200 are preferably longer than the width of the clips 206. If left unrestrained, this excess space may permit the leaves 202 to shift out of complete alignment. The convex heads 228, 230 each include an inside surface 228A, 230A which acts restrain this shifting, and helps to keep the leaves 202 in proper alignment. It will be appreciated that the inside surfaces 228A, 230A of the convex heads 228, 230 and the inside surface 220 of the spine 204 preferably form an extremely elongated U-shape, with the inside surface of the spine forming the base section and the inside surfaces of the convex heads forming the legs.

In an alternative embodiment from the spine 204 having convex heads 228, 230 and the spine walls 30A, 30B having recessed portions 31A, 31B, it is also contemplated that the spine may have concave or dimpled heads while the spine walls have protrusions capable of being mated with the dimpled heads. It is also contemplated that only one of the heads may include structure capable of positive engagement with an end wall. In certain embodiments, one of the end walls may be a flat surface against which the spine may be retained through a friction fit.

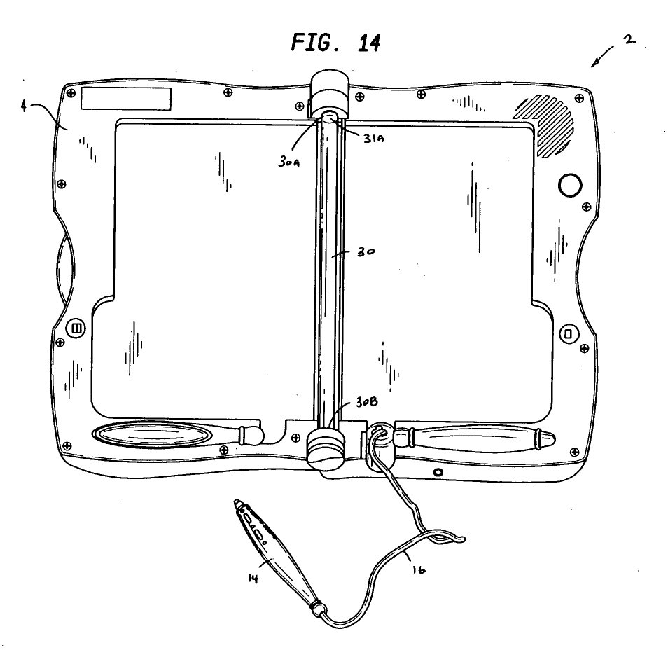

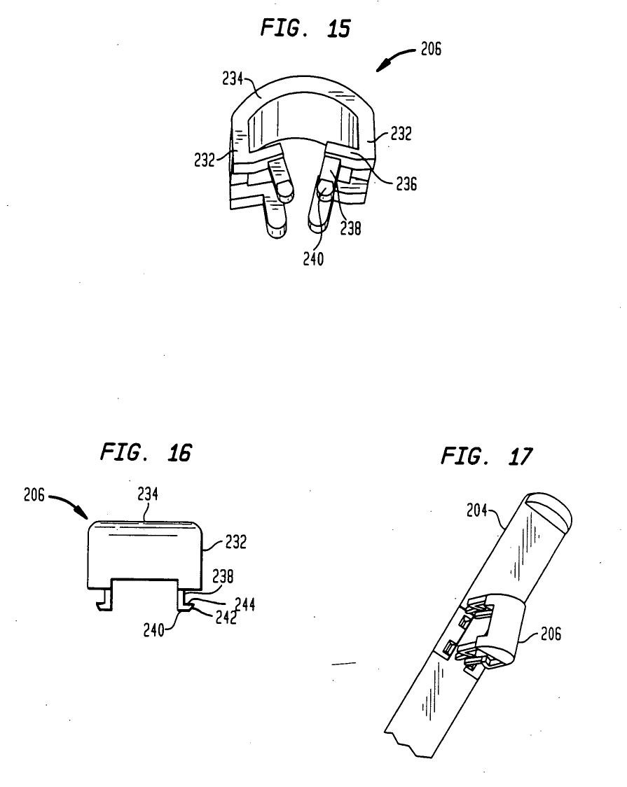

As shown in FIG. 15, the clip 206 may be predominantly U-shaped with a pair of legs 232 extending from the bite area 234. Extending inwardly from each leg 232 are preferably two (2) extension members 236, for a total of four (4) extension members. Each of the extension members 236 may support a tab 238 having a foot 240. A side view of this arrangement is shown in FIG. 16. As clearly shown in the side view, each of the feet 240 ends with a tapered section 242.

FIG. 17 depicts a clip 206 being inserted into a portion of the spine 204. For clarity, the leaves 202 of a book 200, which may be threaded through the clip 206, have not been shown. It will be understood however, that leaves 202 may be threaded through the clip 206 such that they will become attached to the spine 204 once the clip is fully engaged therein. As is shown, the feet 240 of the clip 206 may be inserted into the apertures 216 of the inside surface 220 of the spine 204. Pressure exerted on the tapered section 242 of the feet 240 will then cause the tabs 238 to bend slightly, such that the feet may be inserted into the apertures 216 of the spine 204. Once the feet 240 fully extend through the apertures 216, they are permitted to rebound due to the resilient nature of the materials of which they are constructed, such that the upper portion 244 is adjacent to, and “locks” against, the recessed portion 218 of the spine.

It will be appreciated that this engagement is semi-permanent, in that physical manipulation of the bite portion 234 of the clip 206 should not permit withdrawal of the clip 206 from the spine 204, without inflicting permanent damage to the clip in general, and particularly to the feet 240. On the other hand, selective manipulation of the feet 240 may permit withdrawal of the clip 206 if the feet are aligned perfectly with the apertures 216. Such alignment may be conducted sequentially such that portions of the clip 206 are removed prior to other portions being removed, if not simultaneously. Preferably, the display area 210 of the spine is covered with a sticker (not shown), which may serve to prevent a user from removing the clip 206 without removing the sticker. The sticker (not shown) may also include informational material 212 about the book 200, as previously discussed. As a supplement to the mechanical connection between the spine 204 and the clip 206, the clip, and preferably the feet 240, may be chemical bonded to the spine such as by gluing with an appropriate adhesive.

Typical materials used to construct the leaves 202, including the front cover 202A, rear cover 202D, and interior leaves 202B and 202C, include those used to construct conventional books. To this end, such materials include paper, board and plastics. In addition, the leaves 202 may be constructed of non-typical materials, including Tyvek®. Plastics or Tyveko® have the advantage of being strong, such that the leaves can physically withstand repeated manipulation, page turning, or otherwise using the leaves 202 to remove the spine 204 from the base 4. Plastics or Tyvek® also have the advantage of being waterproof, and thus can withstand being handled by hands of small children, which may be wet or soiled. The books 200 may also be cleansed to ensure that they remain sanitary if constructed of such materials.

Notwithstanding, paper or board books 200 may also be utilized effectively. Although they may not be as durable as other materials, paper or board should have a suitable life span for a book 200 of this type. In addition, paper or board leaves 202 may be reinforced with a laminate or reinforcing material such as plastic material on the entire leave, or in selected areas, to increase durability. As shown in FIG. 11, a reinforced area 205 may be placed adjacent to, and surrounding, the apertures 208 to reinforce the leave 202. Such reinforcement is well known in the industry and may comprise a plastic strip adhesively bonded to the leave or other type of lamination.

It will be appreciated that the leaves 202 of the book 200 may be constructed of combinations of materials. For example, the front cover 202A and rear cover 202D may be constructed of board while the interior leaves 202B and 202C are constructed of paper.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

For example, although the preferred embodiment of the clip 206 has been specifically disclosed as including four feet 240, it is to be understood that a two-footed clip, wherein each of the legs 232 includes a single foot 240, may also be utilized. If such a configuration is employed, it will also be appreciated that the spine 204 may only include a single pair of spaced-apart apertures 216 per recessed area 218, 222, rather than the two pairs of apertures specifically disclosed. The single feet 240 employed may then be formed to provide a one-way type connection with the spine 204, such that they may only be inserted and not removed. The feet 240 in such instance may include an “arrow-tip” type head (not shown), to provide for the one-way attachment.

Other connection mechanisms for connecting the clips 206 to the spine may also be utilized. For example, the clips 206 may be chemically bonded, such as by glue, to the spine 204. The clips 206 may also be mechanically bonded, such as by welding.

1. A binding system adapted to be received by a base, said binding system comprising a removeably securable spine for removeably securing said binding system to the base, and at least one clip securably attached to said spine, wherein said clip is shaped to be threaded through an aperture of a leaf to moveably secure the leaf to said spine.

2. The binding system of claim 1, wherein said spine is elongated and further comprises a plurality of mushroom-shaped ends for securing said binding system into the base.

3. The binding system of claim 2, wherein the base further comprises a well having end walls with opposed dimples, said mushroom-shaped heads being adapted to fit in said dimples to secure said spine to the base.

4. The binding system of claim 1, wherein said spine is elongated and further comprises at least one end shaped to engage the base.

5. The binding system of claim 1, wherein said spine is elongated and further comprises at least one end having a concave surface adapted to engage the base.

6. The binding system of claim 1, wherein said spine is elongated and further comprises one mushroom-shaped end for securing said binding system into the base.

7. The binding system of claim 1, wherein said spine comprises an aperture into which at least a portion of said clip may be inserted to secure said clip to said spine.

8. The binding system of claim 7, wherein said spine comprises a pair of apertures and said clip comprises a first leg and a second leg connected by a bite portion, said first leg adapted to be inserted into one of said apertures and said second leg adapted to be secured within the other of said apertures to secure said clip to said spine.

9. The binding system of claim 2, wherein said spine has an interior surface facing toward the leaf and an exterior surface facing away from the leaf.

10. The binding system of claim 9, wherein said exterior surface is substantially curved from side to side, along the length of said spine.

11. The binding system of claim 10, wherein said mushroom-shaped ends are flush with said curved exterior surface of said spine.

12. The binding system of claim 9, wherein said mushroom-shaped ends extend beyond said interior surface of said spine.

13. The binding system of claim 1, wherein the leaf is capable of lying substantially flat on the base when said spine is secured within the base.

14. A book binding system for use with a base, said binding system comprising:
a removeably securable elongated spine having at least a first aperture opposed from at least a second aperture; and,
at least one clip comprising at least first and second legs sized to be received by said at least first and second apertures for securing said clip to said elongated spine said legs having a bite portion therebetween, said at least first and second legs each comprising an extension member extending therefrom, each said extension member comprising a tab terminating with a foot extending therefrom;
wherein said at least first and second legs are secured through said at least first and second apertures.

15. The book binding system of claim 14, wherein said spine further comprises a third aperture adjacent said first aperture and a fourth aperture adjacent said second aperture, said third aperture being opposed from said fourth aperture, each leg of said clip further comprising second tabs terminating with feet extending therefrom, said feet adapted to be secured within said first, second, third and fourth aperture.

16. The binding system of claim 14, wherein said first pair of apertures and said second pair of apertures are spaced from each other along the width of said spine.

17. The binding system of claim 16, wherein said elongated spine includes a first end and a second end, said first end having a first convex head and said second end having a second convex head.

18. The binding system of claim 17, wherein said spine has an interior surface facing toward the leaves of the book and an exterior surface facing away from the leaves of the book.

19. The binding system of claim 18, wherein said exterior surface is substantially curved from side to side, along the length of said spine.

20. The binding system of claim 19, wherein said first convex head and said second convex head are flush with said curved exterior surface of said spine.

21. The binding system of claim 18, wherein said first convex head and said second convex head extend beyond said interior surface of said spine.

22. The binding system of claim 18, wherein said exterior surface of said elongated spine includes a recessed area encompassing said first pair of apertures and said second pair of apertures.

23. The binding system of claim 22, wherein said recessed area includes indicia of information.

24. The binding system of claim 14, wherein said elongated spine includes a first end and a second end, said first end having a concave surface adapted to engage the base.

25. The binding system of claim 14, wherein said elongated spine includes a first end and a second end, said first end having a convex head adapted to engage the base.

26. The binding system of claim 14, wherein said at least one clip is a plurality of discreet clips.

27. The binding system of claim 14, wherein said at least one clip may be disengaged from said elongated spine without deforming said first leg or said second leg.

28. The binding system of claim 27, wherein said at least one clip may be disengaged from said elongated spine by deformation of said tabs.

29. The binding system of claim 14, further comprising a base having a recessed area adapted to accept said spine of said book.

30. The binding system of claim 29, wherein said print media of said book is adapted to lie substantially flat upon said base.

31. The binding system of claim 29, wherein said recessed area of said base culminates in walls having concave portions and said spine includes ends having convex heads such that said convex heads of said spine fit within said concave portions of said recessed area when said spine is placed within said recessed area.

32. The binding system of claim 29, wherein said recessed area of said base culminates in at least one wall having a convex portion and said spine includes at least one end having a head with a concave portion such that said concave portion fits within said convex portion of said recessed area when said spine is placed within said recessed area.

33. The binding system of claim 29, wherein said recessed area of said base culminates in at least one wall having a concave portion and said spine includes at least one end having a head with a convex portion such that said convex portion fits within said concave portion of said recessed area when said spine is placed within said recessed area.

34. The binding system of claim 14, wherein said binding system forms a portion of an interactive learning device.

35. The binding system of claim 14, wherein said feet include tapered portions for encouraging said tabs to deflect when said feet are inserted into said apertures.

36. The binding system of claim 35, wherein said feet extend completely through said apertures.

37. The binding system of claim 36, wherein said tabs are permitted to spring back to their natural position after said feet are inserted into said apertures such that said clip is retained to said spine by said feet.

38. An apparatus for securing print media comprising:
a base;
a removeably attachable elongated spine; and,
at least one clip adapted to be attached to said spine;
wherein said clip may be threaded through apertures provided in print media and secured to said spine to form a book, said book being adapted for attachment into a recess in said base.

39. The apparatus of claim 38, wherein said spine includes a pair of convex heads and said recess culminates at its extreme ends with concave walls, said convex heads being adapted to fit within said concave walls.

40. The apparatus of claim 39, wherein said print media of said book is adapted to lie substantially flat on said base.

41. The apparatus of claim 38, wherein said spine includes at least one head having a dimpled portion, said dimpled portion adapted to engage a protrusion extending from said recess to secure said spine to said base.

42. The apparatus of claim 38, wherein said spine includes at least one head having a convex portion, said convex portion adapted to engage a concave portion of said recess to secure said spine to said base.

43. A binding system for a book having a plurality of leaves, said binding system comprising:
an elongated spine having a first aperture and a second aperture spaced apart from said first aperture; and,
a clip having first and second legs extending from a bite portion, said first leg having a first foot and said second leg having a second foot;
wherein said first foot and said first leg are adapted to be threaded through apertures provided in the leaves of a book such that the leaves are retained about said clip when said first foot and said second foot are inserted into said apertures of said elongate spine.

44. The binding system of claim 43, wherein said first aperture and said second aperture are spaced from each other along the width of said spine.

45. The binding system of claim 43, wherein said feet are chemically bonded to said spine.

46. The binding system of claim 43, wherein said feet are mechanically bonded to said spine.

47. The binding system of claim 43, further comprising a base having a recessed area adapted to receive said spine of said book.

48. A method of removably securing a first book comprising leaves of print media bound to an elongated spine having end portions to a well formed in the base of an interactive learning device comprising:
placing the elongated spine of the first book into the well of the base such that the spine is removably secured within the well by the end portions of the spine.

49. The method of claim 48, wherein said base further comprises a cartridge port for securing a cartridge associated with a particular book therein, said method further comprising:
inserting a cartridge into said cartridge port, the cartridge being associated with the first book.

50. The method of claim 48, further comprising removing the first book from the base such that the spine is no longer secured within the well by the end portions of the spine.

51. A method of successively securing a plurality of books comprising leaves of print media bound to an elongated spine having end portions to a well formed in the base of an interactive learning device comprising:
placing the elongated spine of a first of the plurality of books into the well of the base such that the spine of the first book is removably secured within the well by the end portions of the spine thereof.

52. The method of claim 51, further comprising removing the first book from the base such that the spine of the first book is no longer secured within the well by the end portions of the spine thereof.

53. The method of claim 52, further comprising placing the elongated spine of a second of the plurality of books into the well of the base such that the spine of the second book is secured within the well by the end portions of the spine thereof.

54. The method of claim 53, further comprising removing the second book from the base such that the spine of the second book is no longer secured within the well by the end portions of the spine thereof.

55. The method of claim 54, further comprising placing the elongated spine of a third of the plurality of books into the well of the base such that the spine of the third book is secured within the well by the end portions of the spine thereof.

56. A method of swapping books from the base of an interactive learning device wherein the books comprise spines having convex end portions adapted to be secured within a well formed in the base, said method comprising:
inserting a first book into a well formed in an interactive learning device such that the convex end portions of the spine of the first book secure the book within the well;
removing the first book from the well; and,
inserting a second book into the well such that the convex end portions of the spine of the second book secure the second book within the well.

57. The method of claim 56, wherein each of the first and second books includes a cartridge associated therewith, and the base includes an input port for the cartridge, the method further comprising removing the cartridge associated with the first book from the cartridge input port and inserting the cartridge associated with the second book into the cartridge input port.

58. A method of swapping books from the base of an interactive learning device wherein the books comprise spines having at lease one concave end portion adapted to be secured within a well formed in the base, the method comprising:
inserting a first book into a well formed in an interactive learning device such that the at least one concave end portion of the spine of the first book secures the book within the well;
removing the first book from the well; and
inserting a second book into the well such that the concave end portion of the spine of the second book secures the second book within the well.
